(19) United States
(12) Patent Application Publication
(10) Pub. No.: US 2025/0054346 A1
(43) Pub. Date: Feb. 13, 2025

(54) DELIVERY CONTAINER WITH SIGNAL-ACTIVATED FASTENER

(71) Applicant: SmartSack, Inc., Los Angeles, CA (US)

(72) Inventor: Kenneth Somuah, Los Angeles, CA (US)

(73) Assignee: SmartSack, Inc., Los Angeles, CA (US)

(21) Appl. No.: 18/682,411

(22) PCT Filed: Aug. 9, 2022
(86) PCT No.: PCT/US2022/039827

§ 371 Date: Feb. 8, 2024

Related U.S. Application Data
(60) Provisional application No. 63/231,659, filed on Aug. 10, 2021.

(51) Int. Cl. G07C 9/00; H04L 9/32; H04W 4/80

(52) U.S. Cl. CPC G07C 9/00309; H04L 9/3236; H04W 4/80; G07C 2009/00769

(57) ABSTRACT

Secure containers for delivery are disclosed. A container includes a storage portion and a closure portion, a fastener configured to fasten and unfasten the closure portion to the storage portion, and a controller. The controller can receive a signal from an external device, and fasten or unfasten the fastener based on the signal. The signal can include a signal to unfasten the container or to fasten the container. The controller can verify the external device prior to unfastening the container by comparing a value received from a second external device to the signal received from the external device.

### CROSS-REFERENCE TO RELATED PATENT APPLICATIONS

This application claims the benefit of and priority to U.S. Provisional Patent Application No. 63/231,659, filed Aug. 10, 2021, the contents of which are incorporated herein by reference in its entirety for all purposes.

### BACKGROUND

Food delivery has become more popular in recent years, in part, due to prevalence of mobile devices, such as smart phones or tablet computers. Some merchants have the capability of delivering food to their customers directly, while others utilize 3rd party delivery services. There are a number of food delivery services that connect merchants and customers through their services. Food delivery through these 3rd party services may be performed by delivery individuals who are neither employees of the merchant nor are related to the customer. The individuals typically have an application on their mobile devices that communicate with local merchants and customers through their respective computers and/or mobile devices. The requested items are delivered in disposable or insecure containers. Customers and merchants want to ensure that the delivery of the food is conducted without any intervention or otherwise being tampered by the delivery individual.

### SUMMARY

The systems and methods described herein provide techniques to ensure secure delivery without any tampering of items, which may be utilized by any third-party delivery services or any establishment that provides items (e.g., food, consumable items, etc.) for delivery. Delivery can be conducted either directly interacting with a merchant or through a third-party party delivery service. Third-party delivery services can employ individuals that utilize mobile applications that can communicate with local merchants and customers. A back-end server can coordinate selection of delivery persons in response to requests for delivery. The systems and methods described herein provide a secure container that may only be accessed by the establishment and the user that requested the delivery. This solution aims to prevent any potential tampering that may occur during delivery.

In one embodiment, a container includes a storage portion and a closure portion; a fastener configured to fasten and unfasten the closure portion to the storage portion; and a controller. The controller may receive a signal from an external device and fasten or unfasten the fastener based on the signal.

The signal may include a value corresponding to the external device. The controller may verify the external device based on the value, and unfasten the fastener responsive to verifying the external device. The signal may include a value corresponding to a second external device. The controller may fasten the fastener responsive to receiving the signal; receive a second signal from the second external device; verify the second external device based on the value and the second signal; and unfasten the fastener responsive to verifying the second external device.

Verifying the second external device may include comparing the value to a second value in the second signal. The fastener may include a solenoid. The fastener may include a latch configured to be fastened by the solenoid. The controller may communicate a second signal to the solenoid to unfasten the fastener. The controller may include a wireless communication interface, and may communicate with the external device via the wireless communication interface. The closure portion may include a zipper disposed along a partial perimeter of the container, and the fastener may be coupled to a portion of the zipper. The signal may be a near-field communication (NFC) signal.

Another embodiment is directed to a system. The system may include one or more processors coupled to a non-transitory memory. The system can receive, from a computing device, a request for one or more secure containers. The request can include an identifier of the computing device. The system can generate a key value based on the identifier of the computing device. The system can identify a second computing device to satisfy the request for the one or more secure containers. The system can transmit the key value to the second computing device when the second computing device establishes communication with the one or more secure containers. The system can transmit a notification upon receiving a message that the computing device instructed one or more fasteners of the one more secure containers to unlock.

The request may include an identifier of the second computing device, and the second computing device may be identified based on the request. Generating the key value may include generating a hash value of the identifier of the computing device. The system may associate the key value with the one or more secure containers upon identifying the second computing device. The system may remove the association between the key value and the one or more secure containers upon receiving the notification. The system may identify the second computing device based on a requested number of the one or more secure containers.

Yet another embodiment is directed to a method. The method includes receiving a request for one or more secure containers, the request comprising an identifier of the computing device. The method can include generating a key value based on the identifier of the computing device. The method can include identifying a second computing device to satisfy the request for the one or more secure containers. The method can include transmitting the key value to the second computing device when the second computing device establishes communication with the one or more secure containers. The method can include transmitting a notification upon receiving a message that the computing device instructed one or more fasteners of the one or more secure containers to unlock.

The request may include an identifier of the second computing device. The second computing device may be identified based on the request. Generating the key value may include generating a hash value of the identifier of the computing device. The method may include associating the key with the one or more secure containers upon identifying the second computing device. The method may include removing the association between the key and the one or more secure containers upon receiving the notification. The method may include identifying the second computing device based on a requested number of the one or more secure containers.

In one aspect, a delivery system is disclosed wherein the system comprises a container comprising a storage portion and a closure portion, and a signal-activated fastener. The signal-activated fastener can fasten and/or unfasten the closure portion to the storage portion. The signal-activated fastener comprises a latch, a solenoid, and a controller. The controller includes a first communication module and an external device comprising a second communication module. The controller and the external device are configured to communicate via the first communication module and the second communication module, and the controller is further configured to apply a control signal to the solenoid when the controller verifies the external device.

The communication module may receive and/or transmit radio waves via Wi-Fi, Bluetooth, and/or Internet. The controller may be configured to communicate a number indicating failed verifications with the external device. The external device may be a desktop, a laptop, or a mobile phone.

Another aspect of the present disclosure is directed to a delivery container. The container comprises a storage portion, a closure portion, and a signal-activated fastener. The signal-activated fastener can fasten and/or unfasten the closure portion to the storage portion. The signal-activated fastener comprises a latch, a solenoid, and a controller. The controller includes a first communication module, and the controller is configured to apply a control signal to the solenoid when the controller verifies an external device.

The controller may verify the external device when an identifying number communicated by the external device matches a predetermined number stored on a storage device of the controller. The container may include a zipper disposed along a partial perimeter of the container, and a puller of the zipper may engage the latch.

In another aspect, a method of delivery is disclosed wherein the method comprises providing a container comprising a storage portion and a closure portion, providing a signal-activated fastener operable to one of fasten and unfasten the closure portion to the storage portion, The signal-activated fastener comprises a latch, a solenoid, and a controller. The controller includes a first communication module. The method may include providing an external device comprising a second communication module. The controller and the external device are configured to communicate via the first communication module and the second communication module, and the controller is further configured to apply a control signal to the solenoid when the controller verifies the external device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using suitable apparatus, which may take the form of programmable computers running computer programs arranged to implement the aspects. As used in the specification and in the claims, the singular form of ‘a’, ‘an’, and ‘the’ include plural referents unless the context clearly dictates otherwise.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure. For purposes of clarity, not every component may be labeled in every drawing. In the drawings:

FIG. 1 illustrates an example system for utilizing a delivery container with a signal-activated fastener according to an embodiment;

FIG. 2 illustrates an example signal-activated fastener coupled to an example delivery container, according to an embodiment;

FIG. 3 illustrates an example signal-activated fastener coupled to a zipper, which may be utilized to secure a delivery container, according to an embodiment;

FIG. 4 illustrates an example signal-activated fastener with an integrated solenoid, which may be utilized to secure a delivery container, according to an embodiment;

FIG. 5 illustrates an example environment where a device can communicate with a signal-activated fastener to open a container, according to an embodiment;

FIG. 6 illustrates various views of a delivery container with a signal-activated fastener, according to an embodiment;

FIG. 7 illustrates example graphical user interfaces showing requests for one or more containers when ordering delivery, according to an embodiment;

FIG. 8 illustrates example graphical user interfaces that may be utilized with the techniques described herein, according to an embodiment;

FIG. 9 illustrates an example graphical user interface showing a list of requests for containers, according to an embodiment; and

FIG. 10 illustrates a flow diagram of an example method for generating keys for containers with signal-activated fasteners, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

When providing delivery services, it is challenging to ensure that intervention or tampering does not occur en route to the delivery destination. Other containers are generally disposable, insecure containers that do not prevent tampering. Tamper-evident seals, like tape or staples in paper bags, may show evidence of tampering, but do not prevent tampering. Likewise, those approaches may not be foolproof in indicating whether tampering has actually occurred, because such sealing techniques may have been damaged during normal transit.

The containers described herein utilize a signal-activated fastener that secure the container until an unlock signal is received from a computing device. The computing device can be a smartphone device, tablet device, or another portable computing device that can be used to place orders for delivery. Upon placing an order with a request for at least one of the containers described herein, a server can generate a key based on a device identifier (or a user profile identifier) of the requesting device. The key can be transmitted to a device of the delivery person (or in some embodiments, a device of a third party, such as the establishment preparing the requested items). Upon arriving at the establishment with the requested container(s), a computing device of the delivery person (or the establishment) can receive the key from the server and communicate the key to the signal-activated fastener to seal the container with the requested items inside. When the container arrives at the location of the requesting party, the requesting computing device can generate a corresponding key (or in some implementations, the server can transmit the key to the requesting computing device) and can utilize a local communication protocol to unlock the container using the key.

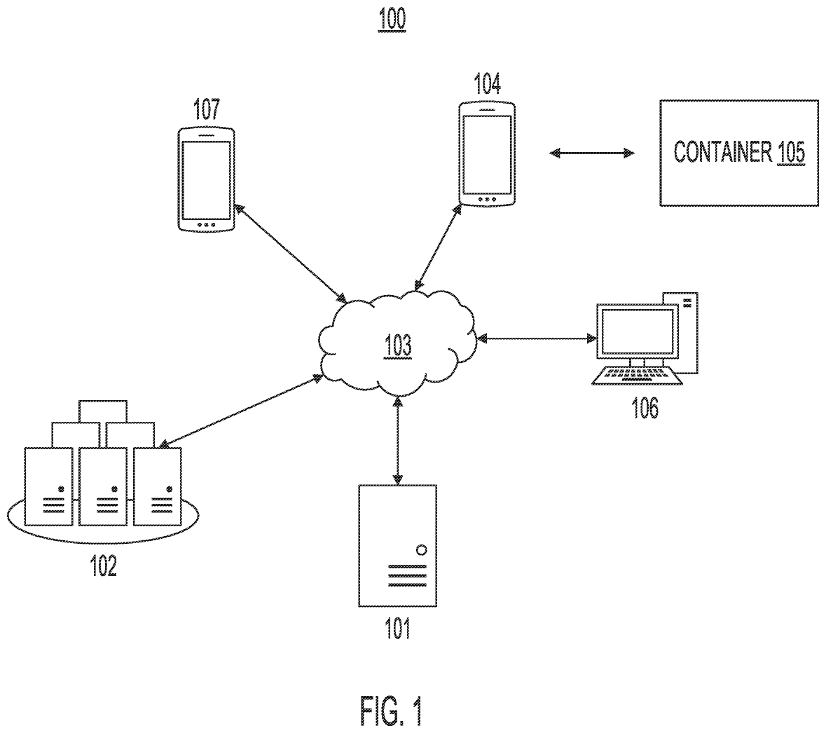

FIG. 1 illustrates an example system 100 for utilizing a delivery container 105 with a signal-activated fastener according to an embodiment. The system 100 may comprise a server 101, a delivery platform 102, a network 103, a requesting device 104, one or more containers 105, an establishment device 106, and a delivery device 107. Although the components of the system 100 are shown and may be referred to in the singular, it should be understood that any number of the components of the system 100 may be utilized to achieve desired results. One having ordinary skill in the art appreciates that the system 100 is not confined to the components described herein and may comprise additional or alternate components. Furthermore, functionality attributed to a component of the system 100 may be fully or partially executed by other components of the system 100.

The server 101 of exemplary system 100 may execute various software modules, or other computer-executable instructions, that instruct the server 101 to perform one or more processes for receiving requests for one or more containers 105, generating a key value for the one or more containers 105, and transmitting the key value to one or more computing devices, such as the requesting device 104, the establishment device 106, or the delivery device 107. The server 101 may be any computing device comprising non-transitory machine-readable storage media and a processor capable of executing the various processes and tasks described herein. Non-limiting examples of a server 101 may include a server computer, a computing device in a datacenter, a desktop, a laptop, a tablet, or the like. In some cases, the server 101 may be coupled to one or more databases or other external memory devices, which may be used to store any of the information accessed by the server 101.

In some embodiments, the server 101 may host an application server or webserver, either of which may include software modules allowing various computing devices (e.g., the requesting device 104, the establishment device 106, the delivery device 107, an administrative computing device (not pictured), etc.) to access and/or manipulate data stored by the server 101. For example, the server 101 may comprise a webserver allowing the various computing devices to access data that is collected and manipulated by the server 101. In this example, a user of the system 100, who may be operating a requesting device 104, may execute a web browser application and access a website hosted on the webserver in order to access the data stored at the and results generated by the server 101.

In another example, the server 101 may provide one or more network-based application programming interfaces (API), which may be invoked by one or more native or web-based applications executing on the computing devices described herein. In this example, the user may utilize the requesting device 104 to execute a native delivery application, which may invoke or otherwise execute one or more APIs of the server 101 to request one or more of the containers 105. In some implementations, the APIs of the server 101 may be invoked by another computing system, such as the delivery platform 102, which may receive requests for delivery from the requesting device 104 and invoke an API call of the server 101 to request one or more of the containers 105.

Additional APIs may be utilized to request and provide one or more of the key values generated by the server 101, as described herein. For example, the delivery device 107 may execute a web-based application (e.g., accessed via a web browser) or a native application and invoke one or more of the APIs of the server 101 to request and receive one or more key values to lock the container 105. In some implementations, the establishment device 106 may execute a web-based application (e.g., accessed via a web browser) or a native application and invoke one or more of the APIs of the server 101 to request and receive one or more key values to lock the container 105. The server 101 can communicate with the various computing devices described herein via the network 103.

The network 103 may be any type of communication medium such as a local area network (LAN), metropolitan area network (MAN), and/or a wide area network (WAN). For instance, the network 103 may be the internet. The network 103 may be a combination of various wired and wireless links capable of carrying data packets between the various computing devices described herein. For example, the network 103 may include wireless cellular networks, which may be accessed by smartphones or cellular-enabled mobile devices, including tablets or laptop computers.

The requesting device 104 and the delivery device 107 may be any type of portable computing device capable of executing delivery applications. Non-limiting examples of the requesting device 104 and the delivery device 107 may be a smart phone, a tablet computer, a laptop computer, or another type of portable computing device. The requesting device 104 and the delivery device 107 may execute an operating system and one or more native applications (e.g., delivery applications) or web browser applications that may access the server 101 via the network 103. For example, the requesting device 104 or the delivery device 107 may execute applications that invoke APIs of the server 101, which may receive or request key values to lock or unlock the container 105.

The delivery platform 102 can include one or more servers or computing devices that operate a third-party delivery service. The delivery platform 102 can communicate with the delivery devices 107 of one or more remote drivers via the network 103 to coordinate delivery. The requesting device 104 can execute an application corresponding to the delivery platform 102, which may be a native application or a web-based application, to access the ordering functionality of the delivery platform 102. In some implementations, the native application or web-based application of the delivery platform 102 can implement or invoke the APIs of the server 101, as described herein, to request one or more containers 105 or to implement other techniques described herein. In some implementations, the delivery platform 102 may transmit the request for one or more containers 105 to the server 101 using one or more corresponding APIs, in response to receiving a request for delivery from the requesting device 104.

Additionally, the delivery platform 102 may transmit one or more identifiers of the establishment device 106 to the server 101, which can be a computing device of the establishment from which the user ordered items. The delivery platform 102 can also transmit an identifier of the delivery device 107 of a selected delivery person to the server 101, following a delivery-person selection process performed by the delivery platform 102. In some implementations, the delivery platform 102 can select a delivery person (and therefore a delivery device 107) based on a status of the delivery person. The status of the delivery person may include a current location of the delivery person, whether the delivery person is in possession of one or more containers 105, and whether the delivery person is currently making a delivery, among others. The delivery platform 102 may receive confirmation messages that requested deliveries have been completed, for example, from the requesting device 104 upon the requesting device 104 unlocking the one or more containers 105 associated with the delivery.

The establishment device 106 may be a computing device of an establishment that can satisfy orders from the requesting device 104. Non-limiting examples of the establishment device 106 may include a server device, a desktop computer, a smart phone, a tablet computer, a laptop computer, or another type of computing device. The establishment device 106 can receive requests for orders from the delivery platform 102 and can store records of orders in the memory of the establishment device 106. In some embodiments, the establishment device 106 may receive a key value to provide and configure a signal-activated fastener of a container 105 corresponding to an order. The key value may be received, for example, from the server 101 via one or more corresponding APIs, or from the delivery platform 102 upon receiving the key value from the server 101. Upon confirmation of an order being picked up from the establishment, the establishment device 106 can transmit a corresponding signal to the delivery platform 102 indicating that the order is out for delivery.

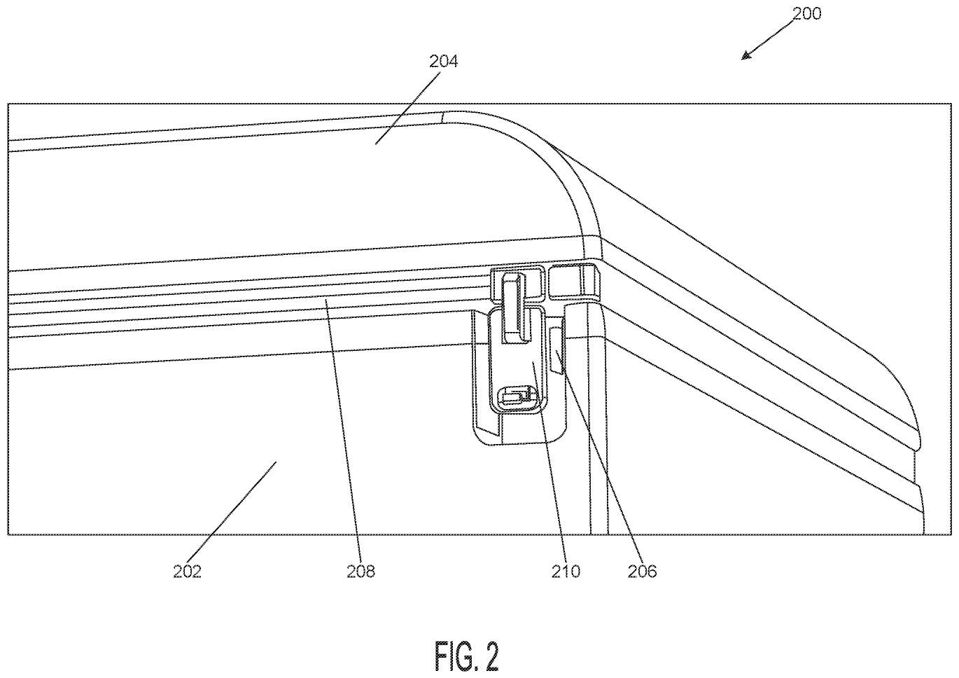

The container 105 can be any type of container that is capable of securely containing ordered items. The container 105 can be secured with a signal-activated fastener. The container 105 can include a storage portion, which can be used to store items for delivery, and a closure portion, that can be used to secure the items from tampering or other interference. The container 105 can include a fastener that can fasten and unfasten the closure portion to the storage portion, enabling the container to secure items upon pickup at the establishment from which the items were ordered, and unsecure the items upon delivery to a delivery location. The container 105 can include a controller that receives a signal from external devices, such as the requesting device 104, the delivery device 107, or the establishment device 106, and can fasten or unfasten the fastener based on the signal. Further details of the operation of the container 105 and the controller are described in connection with FIGS. 2-6.

In an example operation, the server 101 can receive a request for one or more containers 105. The request may be transmitted, for example, by the requesting device 104. In some embodiments, the request may be transmitted by the delivery platform 102, in response to a delivery request transmitted by the requesting device 104. The request for the one or more containers 105 can include an identifier of the requesting device 104. The identifier can be a device identifier, such as a globally unique identifier (GUID) or a universal unique identifier (UUID), or an identifier of a user profile of a user of the requesting device 104. In response to the request, the server 101 can generate a key value using the identifier. The key value can be used to lock or unlock a signal-activated fastener on the container. The server 101 can then identify a second computing device to satisfy the request for the one or more containers 105. The second computing device may be the establishment device 106 or the delivery device 107. The second computing device is responsible for locking the requested containers 105 and providing the signal-activated fastener with the generated key. The generated key may be transmitted to the identified computing device to lock the container 105. The requesting device 104 can then generate a corresponding key value (e.g., using a similar key generation process) to unlock the container 105 upon delivery. The system 100 therefore ensures the safe delivery of items in a container 105 that prevents tampering during delivery.

Referring to FIG. 2, illustrated is an example signal-activated fastener coupled to an example delivery container, according to an embodiment. Depicted is a perspective side view of a delivery container 200, which may be similar to the container 105 described in connection with FIG. 1. The container 200 includes a storage portion 202 and a closure portion 204. The container 200 further includes a signal-activated fastener 206, which can fasten or unfasten the closure portion 204 to the storage portion 202. The container 200 can be any type of container, including a flexible container, a rigid container, or combinations thereof. The container 200 can be manufactured from any type of suitable material, including a cloth material, a polyester material, an insulator material, a rigid plastic material, a metal material, combinations thereof, or the like. In some implementations, the storage portion 202 may include one or more thermal devices, such as a battery-powered warming device, to keep certain items (e.g., food) warm during transit. Likewise, the storage portion 202 may also include one or more built-in (or removable) ice packs or freezable portions to keep food cool during transit.

The signal-activated fastener 206 can include a latch (not shown here for visual clarity), a solenoid (not shown here for visual clarity), and a controller (not shown here for visual clarity). The controller can be any type of portable computing device that is capable of transmitting or receiving signals. The controller maybe analog or digital, such as a microcontroller. In one preferred embodiment, the microcontroller is a 68HC08 processor having internal flash memory available from Freescale of Austin, Texas. It is contemplated that the processor may be a combination of individual discrete or separate integrated circuits packaged in a single housing or it may be fabricated in a single integrated circuit. The communication module may be the SMD Module-RN-42 available from SparkFun Electronics of Niwot of Colorado.

In one example, the controller can include a communication module that may communicate wirelessly with other computing devices (e.g., the requesting device 104, the establishment device 106, or the delivery device 107 of FIG. 1). The controller can generate and provide signals to the signal-activated fastener 206 to cause the fastener to lock or unlock. The controller can do so, for example, by verifying an identity of an external device (e.g., the requesting device 104). The controller can do so by comparing a key value received from the external device with a key value stored in memory of the controller. The key value may be a device identifier of the external device or derived from (e.g., a hash value, an encrypted value, etc.) the device identifier of the external device.

The container 200 can include a sealing mechanism, such as a zipper 208, that is disposed along a partial perimeter of the container 200. Alternative sealing mechanisms are also possible, such as rigid clamp-based sealing mechanisms (e.g., with one or more gaskets or other water-tight seals), among others. Furthering the example where the container 200 includes the zipper 208, the zipper 208 can include a puller 210, which can engage the latch of the container 200. Although only one signal-activated fastener 206 is shown here, it should be understood that any number of signal-activated fasteners may be provided on a container 200. Each signal-activated fastener can be in communication with the controller of the container 200 and can receive signals to lock or unlock the container 200.

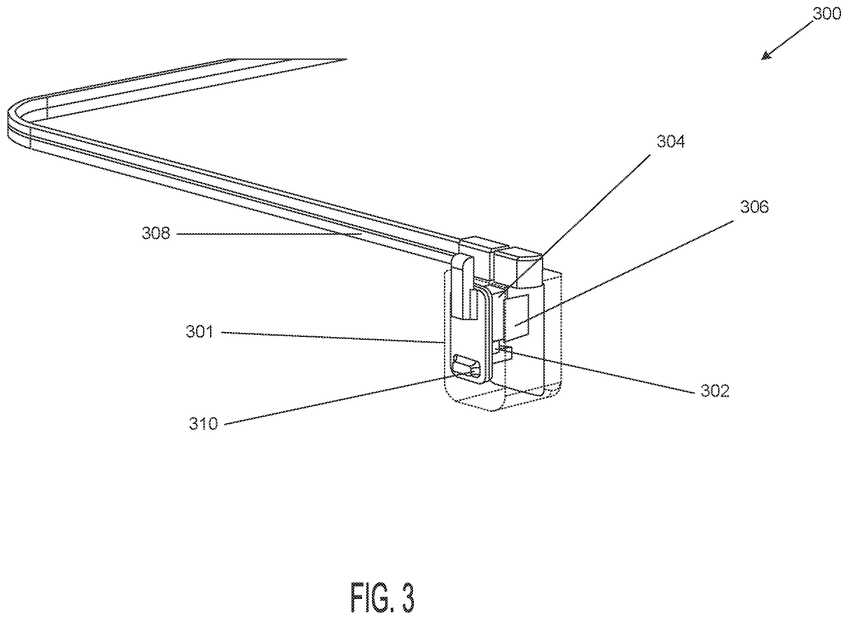

Further details of the zipper 208 are described in connection with FIG. 3. Referring briefly to FIG. 3, illustrated is a perspective view of a signal-activated fastener 300 which includes a housing 301, a latch 302, a solenoid 304, and a controller 306. A zipper 308 has a puller 310 which engages the latch 302. The controller 306 may be similar to the controller described in connection with FIG. 2, the zipper 308 may be similar to the zipper 208 described in connection with FIG. 2, and the puller 310 may be similar to the puller 210 described in connection with FIG. 2. The puller 310 and the zipper 308 may be positioned external to the housing 301, with a portion of the puller 310 extending into the housing 301 to couple with the latch 302.

As shown, the controller 306 is positioned within the housing 301 with the latch and the solenoid 304. Although not shown from the angle depicted in FIG. 3, the solenoid can secure or unsecure the latch 302, depending on whether the solenoid 304 is in a powered or unpowered state. If powered, the solenoid 304 can push the latch 302 outward into the puller 310, preventing the puller 310 from moving and effectively keeping the container sealed. However, if the solenoid 304 is unpowered, the solenoid 304 retracts the latch 302, allowing the puller 310 to move along the zipper 308 to unseal the bag. The controller 306 can be electrically and communicatively coupled with the solenoid 304, and can generate and provide signals to power or remove power from the solenoid 304.

The solenoid 304 can be any type of device that includes a coil of wire surrounding a movable magnetic core, which in some embodiments can be the latch 302. The magnetic field can be generated by circulating an electric current through the coil of wire of the solenoid 304, which in turn can force the latch 302 in and out of the device. The movable magnetic core can protrude into the latch 302 of the puller 310, preventing the puller 310 from moving along the zipper 308. A signal to unlock the latch 302 provided by the controller 306 can be generated in response to verifying a device identifier of the requesting device 104. The signal-activated fastener 300 may include power circuitry that receives signals from the controller 306 and provides power to the solenoid to extend or retract the latch 302. The signal-activated fastener 300 can include one or more batteries or power-storage components (not pictured), which provide power to the various components of the signal-activated fastener 300.

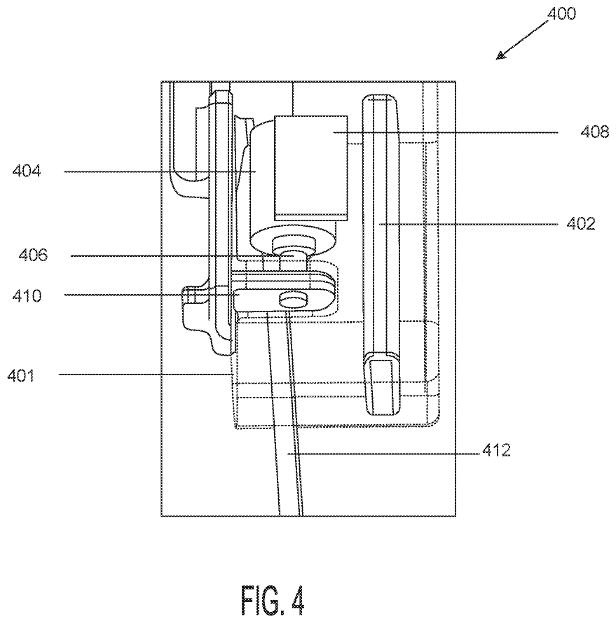

Referring to FIG. 4, illustrated is an example signal-activated fastener 400 with an integrated solenoid 404, which may be utilized to secure a delivery container (e.g., the container 200 of FIG. 2), according to an embodiment. Depicted is a perspective view of a signal-activated fastener 400, which includes a battery 402 as its power source. The signal-activated fastener 400 may be similar to the signal-activated fastener 300 of FIG. 3, and may include a housing 401, a solenoid 404 (which may be similar to the solenoid 304 of FIG. 3), a latch 406 (which may be similar to the latch 302 of FIG. 3), a controller 408 (which may be similar to the controller 306 of FIG. 3), a puller 410, and a zipper 412. The puller 410 and the zipper 412 may be similar to the puller 310 and the zipper 308 of FIG. 3, respectively.

As shown, the puller 410 of the zipper 412 includes a portion that protrudes into the housing 401. The protruding portion includes an opening, which can engage the latch 406 when the latch 406 is forced outward by the solenoid 404. In the depicted embodiment, the housing 401 includes an opening through which the latch 406 protrudes when forced outward by the solenoid 404. The battery 402 is positioned near the wall of the housing behind the solenoid 404. Although not shown here, the battery may be electrically coupled to the controller 408 and the solenoid 404, and may be coupled to power circuitry (not pictured) which can coordinate electrical power to the solenoid 404 based on signals generated by the controller 408. The power circuitry may include charging circuitry, which may receive power from an external port (e.g., a universal serial bus (USB) port or another a direct-current (DC) power port) and charge the battery 402. The battery 402 may be any type of suitable re-chargeable battery, including but not limited to lithium-ion batteries, lithium polymer batteries, nickel cadmium batteries, or the like.

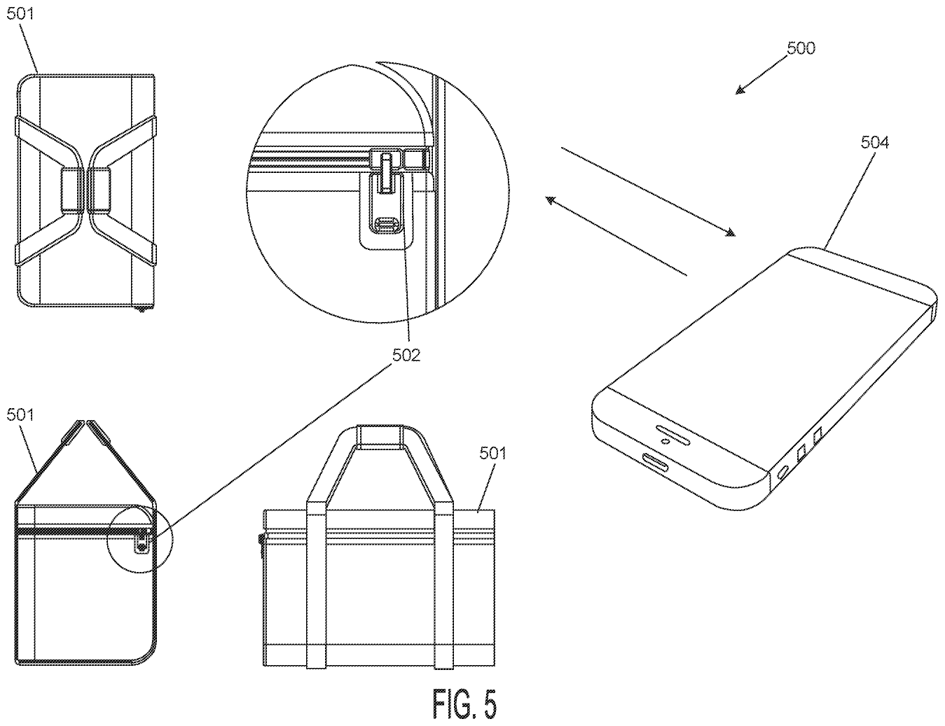

Referring to FIG. 5, illustrated is an example environment 500 where a device 504 can communicate with a signal-activated fastener 502 to open a container 501, according to an embodiment. Depicted are several views of the delivery container 501, which may be similar to the container 105 of FIG. 1 and the container 200 of FIG. 2. The container 501 includes a signal-activated fastener 502, which is pictured here as being fastened. The signal-activated fastener 502 can be fastened manually, for example, by a delivery person or by an employee of the preparation establishment. In some implementations, a device (e.g., the establishment device 106 or the delivery device 107 of FIG. 1) can communicate one or more signals to configure a controller of the signal-activated fastener 502 with a key value, which may cause the controller to generate a signal to fasten the signal-activated fastener 502.

As shown, the signal-activated fastener 502 (which includes a controller that may be similar to the controller 306 of FIG. 3, or the controller 408 of FIG. 4) can communicate with an external device 504 (e.g., the requesting device 104 of FIG. 1). The signal-activated fastener 502 can generate a control signal to its solenoid (not shown in this figure) to unfasten the signal-activated fastener 502 and provide access to the container 501. In an embodiment, the signal-activated fastener 502 can verify the external device 504 prior to generating and providing the control signal. In one embodiment, the controller of the signal-activated fastener 502 can store a key value that was generated by a server (e.g., the server 101 of FIG. 1) and provided to the controller by another external device (e.g., the establishment device 106 or the delivery device 107 of FIG. 1). To do so, the controller of the signal-activated fastener can compare an identifying number communicated by the external device 504 to the key value. If there is a match, the controller can generate the control signal to the solenoid to open the container 501.

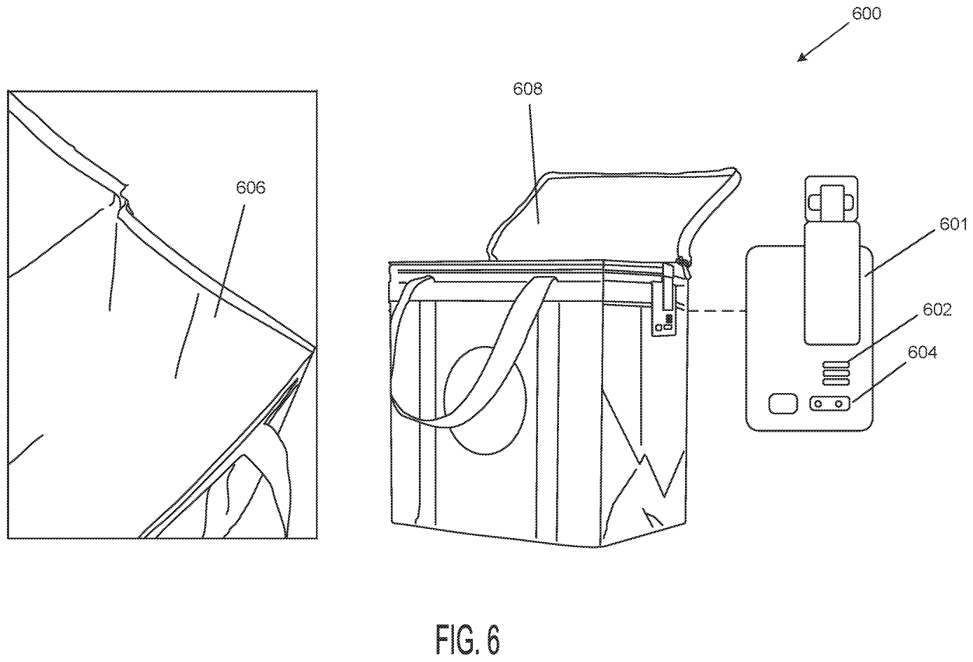

Referring to FIG. 6, illustrated are various views of a delivery container 600 with a signal-activated fastener 602, according to an embodiment. The container 600 may be similar to the container 105 or the container 200 described in connection with FIGS. 1 and 2. As shown, the container 600 includes a storage portion 606 and a closure portion 608, which may be similar to the storage portion 202 and the closure portion 204 of FIG. 2, respectively. The container can include a signal-activated fastener 601, which may be similar to the signal-activated fasteners described in connection with FIGS. 2-5.

The signal-activated fastener 601 can include one or more visual indicators 602, which may indicate a status of the container 600 or the components thereof. In an example, the signal-activated fastener 601 can include a visual indicator 602 that indicates whether the container 600 is secured (e.g., a “lock” indicator). The signal-activated fastener 601 can include one or more visual indicators 602 indicating a charge level of the battery in the signal-activated fastener 601. The signal-activated fastener 601 can include a visual indicators indicating whether verification of an external device (e.g., the requesting device 104, etc.) was successful. The various visual indicators 602 of the signal-activated fastener 601 can be controlled by the controller of the signal-activated fastener 601 or by other circuitry, such as power circuitry.

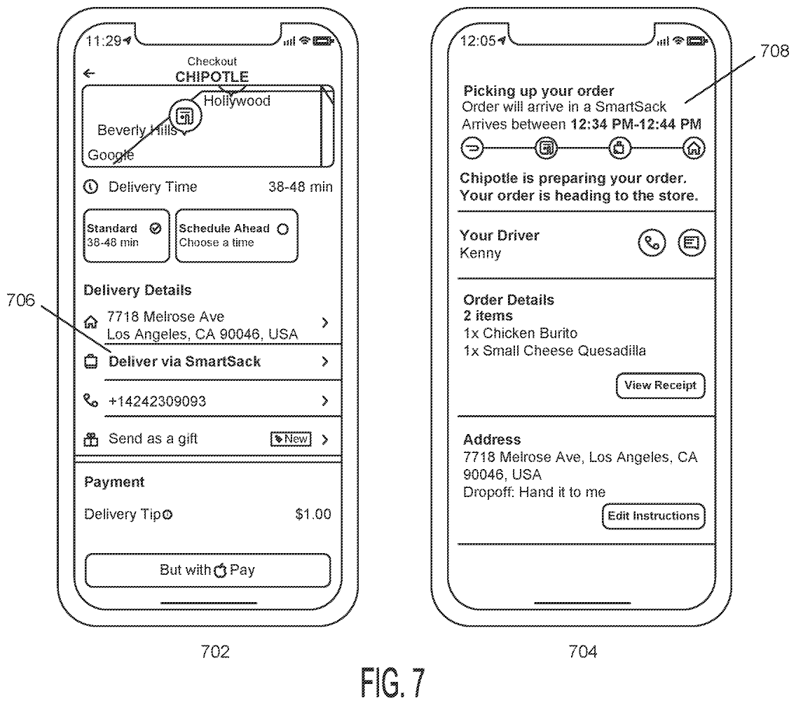

Referring to FIG. 7, illustrated are example graphical user interfaces 702 and 704 that can be displayed in an application executed on an external device, such as the requesting device 104 of FIG. 1. The application may be a delivery application, and may be executed as a web-based application in a web browser, or as a native application on the external device. As shown, the graphical user interface 702 includes the interactive user interface element 706, which enables a user to request with one or more secure containers (e.g., the containers 105, the containers 200, among other containers with signal-activated fasteners described herein), which is shown here as “Order with SmartSack.” Activating the interactive element and completing the order by providing payment can cause the application executing on the external device to transmit a request for one or more containers to a server (e.g., the server 101), which can generate one or more keys for requested containers using the techniques described herein. In some embodiments, the request for one or more containers can be transmitted to a delivery platform (e.g., the delivery platform 102), which may then forward the request for the containers to the server. The graphical user interface 704 shows a status of the order after the order has been placed, the details of which may be received from the delivery platform. As shown, the graphical user interface 704 includes an indication that the delivery will arrive in a secure container (shown here as “Order will arrive in a SmartSack”).

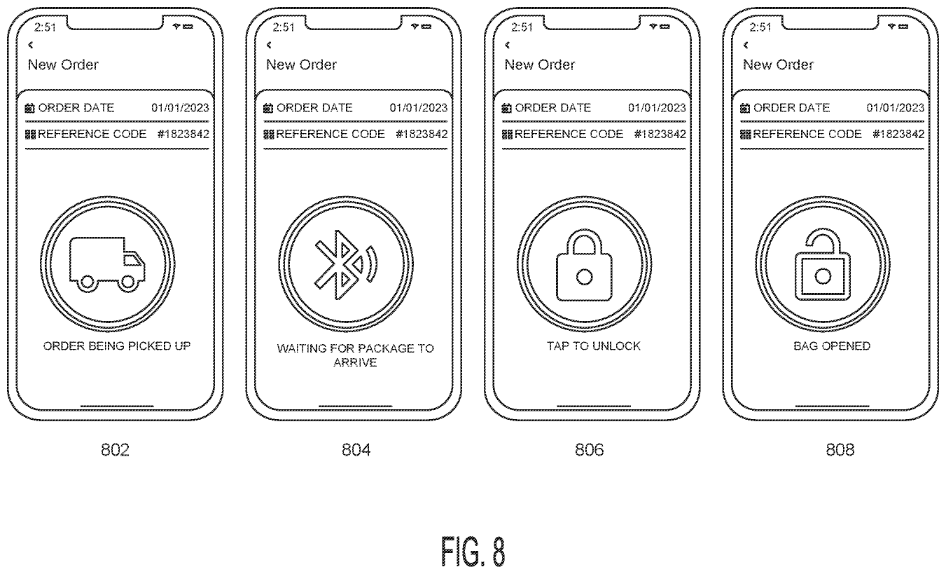

Referring to FIG. 8, illustrated are example graphical user interfaces 802, 804, 806, and 808 that show different statuses of a delivery order that will arrive in a secure container (e.g., the containers 105, the containers 200, among other containers with signal-activated fasteners described herein), according to an embodiment. The graphical user interfaces 802, 804, 806, and 808 can be displayed in an application executing on an external device (e.g., the requesting device 104). The application may be a delivery application, and may be executed as a web-based application in a web browser, or as a native application on the external device. The graphical user interface 802 shows a status of an order before the order has been picked up by a delivery person. The graphical user interface 802 includes the date of the order and an identifier of the order. The graphical user interface 804 shows the status of the order after the order has been picked up by a delivery person and prior to being dropped off at the delivery location. The graphical user interface 806 shows the status of the order after the order has been delivered by a delivery person, and prior to unlocking the secure container. The graphical user interface 808 shows the status of the order after the secure container has been opened by the user.

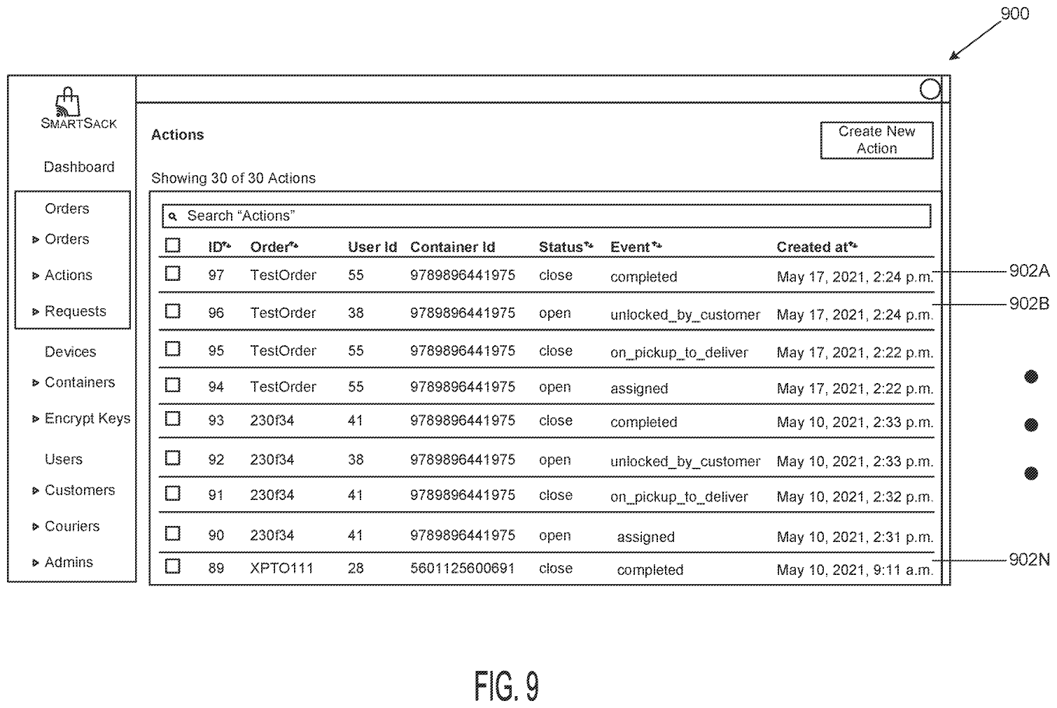

Referring to FIG. 9, illustrated is an example graphical user interface 900 showing a list of requests for containers (e.g., the containers 105, the containers 200, among other containers with signal-activated fasteners described herein), according to an embodiment. The graphical user interface 900 can be displayed on an administrative computing system, which may be in communication with, or may be, a server (e.g., the server 101) that generates one or more key values to unlock the containers. As shown, the graphical user interface 900 can include a number of rows 902A-902N (sometimes referred to herein as the “row(s) 902”). Each row 902 can correspond to a respective order, and may include an identifier of the order and a status of the order, which may indicate whether the order has been completed or assigned, or whether the container has been unlocked by the customer. Each row 902 may further include an identifier of the container that has been assigned to each order (e.g., the container(s) of the assigned delivery person, which may be obtained from a delivery platform), as well as an identifier of a user that requested the delivery and a timestamp of when the delivery was placed. The graphical user interface 900 of FIG. 9 may be updated in response to signals received from the various computing devices described herein when conducting deliveries. For example, a delivery device (e.g., the delivery device 107) may transmit a signal indicating that a container is locked and en route to the delivery location. A requesting device (e.g., the requesting device 104) may transmit a signal indicating that a container has been successfully unlocked, and the delivery has been completed.

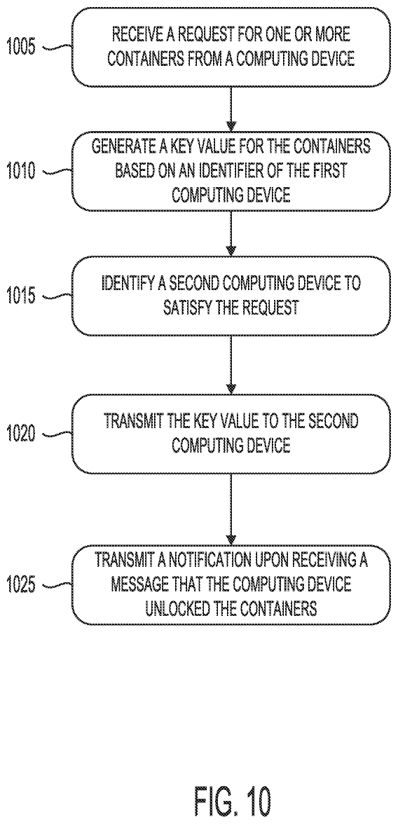

FIG. 10 illustrates a flow of a method 1000 executed in a system (e.g., the server 101, other computing systems described herein, etc.) for generating keys for containers with signal-activated fasteners, in accordance with an embodiment. The method 1000 includes steps 1005-1025. However, other embodiments may execute steps in an alternative order, may include additional or alternative steps, or may omit one or more steps altogether. The method 1000 is described as being executed by a server, such as the server 101 of FIG. 1.

Step 1005 of the method 1000 can include receiving a request for one or more containers (e.g., the containers 105, the container 200, any other containers with signal-activated fasteners described herein) from a requesting device (e.g., the requesting device 104). The request comprises an identifier of the computing device. The request can be part of a delivery request for one or more items. In an embodiment, the request can be provided to the server from a delivery platform (e.g., the delivery platform 102), in response to a corresponding delivery request from the requesting device. The request may include information relating to the delivery, such as an order identifier, a number of containers required to satisfy the order, a delivery location, a device identifier of a delivery device (e.g., the delivery device 107) of the delivery person assigned to the order, or the like. Upon receiving the request, the server can generate an electronic data record for the order and store the electronic data record in a database or another memory accessible to the server. The data records corresponding to orders may be accessible via one or more user interfaces, such as the graphical user interface 900 shown in FIG. 9.

Step 1010 of the method 1000 can include generating a key value based on the identifier of the requesting computing device. Upon receiving the request for the one or more containers, the server can generate one or more key values that can be used by the requesting device to unlock the one or more containers once they have been delivered. A key value can be any value that can be used to verify the identity of the requesting device. For example, the key value may be an identifier of the requesting device (e.g., a GUID, a UUID, a device name, or the like), a hash of the identifier of the requesting device, a randomly generated value that corresponds to the order, or combinations thereof.

Generating the key value can include executing a hashing algorithm over an input value, which may be the identifier of the requesting device, an identifier of a user profile associated with the order, or another identifier associated with the order or the container. In an embodiment, the server can generate a single key value for all containers utilized for an order. In another embodiment, the server can generate a respective key value for each container utilized in the order (e.g., a set of key values), each of which may be generated utilizing a respective input value with a hashing algorithm or a respective identifier.

Step 1015 of the method 1000 can include identifying a second computing device (e.g., the establishment device 106 or the delivery device 107 of FIG. 1) to satisfy the request for the one or more containers. Upon generating the key value(s) that can be used to unlock the containers, the server can identify a second computing device that can configure the controller of the requested containers, such that the containers can be unlocked by the requesting device. In an embodiment, the request for the one or more containers may include an identifier of the second computing device, and the second computing device can be identified from the request. In another embodiment, the server can request an identifier of the second computing device from the delivery platform. In response, the delivery platform can transmit an identifier of the delivery device to the server, for example, via one or more API calls of the server. Alternatively, the server may identify the delivery platform itself as the second computing device, and the delivery platform can carry out the distribution of the key value to the delivery device (or establishment device) associated with the order.

In another embodiment, the server may execute a delivery person selection algorithm to identify possible delivery persons available to satisfy the order. In such an embodiment, the server may select a delivery person from a set of available candidate delivery persons. The server can select the delivery person based on a status of each candidate delivery person. The status of each delivery person may include a current location of the delivery person, whether the delivery person is in possession of one or more containers, a number of containers in the possession of the delivery person, and whether the delivery person is currently making a delivery, among others. In an example, the server may select a delivery person based on a number of the containers required to satisfy the order. Delivery persons that are not in possession of the requisite number of containers can be filtered from the candidate set of delivery persons. Upon selecting a delivery person, the second computing device can be identified as the delivery device of the delivery person. The server can therefore, in an embodiment, identify the second computing device based on the number of containers requested in the order.

Upon identifying the computing device associated with the order, the server can identify the one or more containers that will be used to satisfy the order. For example, a database may store associations between delivery devices and containers that are in the possession of a delivery driver. Furthering this example, the server can identify the one or more containers by looking up the corresponding container identifier(s) in the database. In another embodiment, the establishment device or the delivery device may transmit identifiers of one or more containers that will be used to satisfy the order, for example, in response to a request from the server, or when the delivery person accepts the order via communications with the delivery platform. Upon identifying the containers that will be utilized to satisfy the order, the server can update the data records corresponding to the order with an association between the generated key value and the identifier of the container. In an embodiment, the server may generate the key value responsive to identifying the one or more containers for the order.

Step 1020 of the method 1000 can include transmitting the key value to the second computing device. The key value can be utilized by the second computing device to configure and secure the one or more containers, such that they may only be unlocked by the requesting device. The key value(s) may be transmitted to the second computing device. Once the delivery person has placed the delivery items (e.g., food, electronics, or the like) within the containers, the delivery person can interact with an application executing on the second computing device. In response to the interaction, the application can communicate with the one or more containers via a communication protocol. The communication protocol may be a wireless communication protocol, such as wireless fidelity (Wi-Fi), Bluetooth, cellular communications, or NFC. Upon establishing a communication channel between the second computing device and the one or more containers, the application can communicate the generated keys to the one or more containers with a lock signal. The key value(s) can be stored in a memory of the controller, and the controller can generate a control signal for a solenoid of a signal-activated fastener to lock the container, as described herein. Upon transmitting the key values, the application of the second computing device can delete or remove the key values from its memory. The second computing device can transmit a message to the server indicating that the one or more containers have been locked.

In an embodiment, the server can transmit the key values to the second computing device when the second computing device establishes communication channel with the one or more containers (e.g., via Wi-Fi, Bluetooth, cellular communication, NFC, or the like). The second computing device can then provide the key values to the one or more containers to configure the one or more containers. In another embodiment, the server can communicate the key values to the one or more containers associated with the second computing device via a network (e.g., the network 103). Upon configuring the one or more containers, the application on the second computing device can automatically delete or remove the key values from the memory of the second computing device. The second computing device can transmit a message to the server indicating that the one or more containers have been locked or configured.

Upon receiving the message, the server can update the data record associated with the order to indicate that the one or more containers are in a locked state. The delivery person can then deliver the one or more containers to the delivery location specified in the order. Upon arrival, a requesting user can interact with an application executing on the requesting device to communicate with the controller of the one or more containers. Upon receiving the interaction, the application on the requesting device can generate one or more key value(s), which may match the key value(s) that were generated by the server for the one or more containers. To do so, the requesting device may execute similar functions or operations (e.g., a device identifier lookup, executing a hash function, etc.) to generate the same key values. In another embodiment, the requesting device can transmit a request to the server for the one or more key values, and in response, the server can transmit the one or more key values to the requesting device.

Upon generating or receiving the key values, the requesting device can communicate each assigned key value to the controllers of the one or more containers with an unlock signal. Upon receiving the key values and the unlock signal, the controller can compare the key value received from the requesting device to the key value stored in the memory of the controller. If multiple containers are present and a respective key value has been assigned to each container, the server may provide an indication of which key value is associated with which container, and the application on the requesting device can communicate with the controller of each container using the key value assigned to that container. If the controller detects a match between the received key value and the stored key value, the controller can generate and provide an unlock signal to the signal-activated fastener, which disengages the solenoid and unlocks the container. The controller may then transmit an indication that the container was unlocked successfully to the requesting device. Otherwise, the controller can transmit an error message to the requesting device, with an indication that the key value is invalid.

Step 1025 of the method 1000 can include transmitting a notification upon receiving a message that the computing device instructed one or more fasteners of the one or more secure containers to unlock. Upon receiving the indication that the container was unlocked successfully, the requesting device can transmit a corresponding message to the server. The server can then update the order status to a completed state, and remove the association between the one or more key values and the one or more containers. The completed order status may also be transmitted to the delivery platform, which may update its own electronic data records for the order to indicate the updated status. The server can transmit a notification to the second computing device, which can indicate that the one or more containers have been unlocked by the requesting device, and that the order has been completed. The items stored in the one or more containers can be removed by the requesting user, and the delivery person can then utilize the one or more containers for future deliveries based on the techniques described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means, including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable medium includes both computer storage media and tangible storage media that facilitate transfer of a computer program from one place to another. A non-transitory processor-readable storage medium may be any available medium that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The operations described in this specification can be implemented as operations performed by a data processing apparatus on data stored on one or more computer-readable storage devices or received from other sources.

The terms “data processing apparatus,” “data processing system,” “client device,” “computing platform,” “computing device,” “computing system,” “user device,” or “device” can encompass all kinds of apparatuses, devices, and machines for processing data, including, by way of example, a programmable processor, a computer, a system on a chip, or multiple ones, or combinations, of the foregoing. The apparatus can include special purpose logic circuitry, e.g., a field-programmable gate array (FPGA) or an application-specific integrated circuit (ASIC). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global-positioning system (GPS) receiver, a digital camera device, a video camera device, or a portable storage device (e.g., a universal serial bus (USB) flash drive), for example. The processor and the memory can be supplemented by, or incorporated in, special purpose logic circuitry.

To provide for interaction with a user, implementations of the subject matter described in this specification can be implemented on a computer having a display device, e.g., a cathode ray tube (CRT), plasma, or liquid-crystal display (LCD) monitor, for displaying information to the user; a keyboard; and a pointing device, e.g., a mouse, a trackball, or a touchscreen, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the computing devices described herein can each be a single module, a logic device having one or more processing modules, one or more servers, or an embedded computing device.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A container, comprising:
a storage portion and a closure portion;
a fastener configured to fasten and unfasten the closure portion to the storage portion; and
a controller configured to:
receive a signal from an external device; and
fasten or unfasten the fastener based on the signal.

2. The container of claim 1, wherein the signal comprises a value corresponding to the external device, and wherein the controller is further configured to:
verify the external device based on the value; and
unfasten the fastener responsive to verifying the external device.

3. The container of claim 1, wherein the signal comprises a value corresponding to a second external device, and wherein the controller is further configured to:
fasten the fastener responsive to receiving the signal;
receive a second signal from the second external device;
verify the second external device based on the value and the second signal; and
unfasten the fastener responsive to verifying the second external device.

4. The container of claim 3, wherein verifying the second external device comprises comparing the value to a second value in the second signal.

5. The container of claim 1, wherein the fastener comprises a solenoid.

6. The container of claim 5, wherein the fastener comprises a latch configured to be fastened by the solenoid.

7. The container of claim 5, wherein the controller communicates a second signal to the solenoid to unfasten the fastener.

8. The container of claim 1, wherein the controller comprises a wireless communication interface and communicates with the external device via the wireless communication interface.

9. The container of claim 1, wherein the closure portion comprises a zipper disposed along a partial perimeter of the container, and the fastener is coupled to a portion of the zipper.

10. The container of claim 1, wherein the signal is a near-field communication (NFC) signal.

11. A system, comprising:
one or more processors coupled to a non-transitory memory, the one or more processors configured to:
receive, from a computing device, a request for one or more secure containers, the request comprising an identifier of the computing device;
generate a key value based on the identifier of the computing device;
identify a second computing device to satisfy the request for the one or more secure containers;
transmit the key value to the second computing device when the second computing device establishes communication with the one or more secure containers; and
transmit a notification upon receiving a message that the computing device instructed one or more fasteners of the one more secure containers to unlock.

12. The system of claim 11, wherein the request comprises an identifier of the second computing device, and wherein the second computing device is identified based on the request.

13. The system of claim 11, wherein generating the key value comprises generating a hash value of the identifier of the computing device.

14. The system of claim 11, wherein the one or more processors are further configured to:
associate the key value with the one or more secure containers upon identifying the second computing device; and
remove the association between the key value and the one or more secure containers upon receiving the notification.

15. The system of claim 11, wherein the one or more processors are further configured to identify the second computing device based on a requested number of the one or more secure containers.

16. A method, comprising:
receiving, by one or more processors coupled to a non-transitory memory, from a computing device, a request for one or more secure containers, the request comprising an identifier of the computing device;
generating, by the one or more processors, a key value based on the identifier of the computing device;
identifying, by the one or more processors, a second computing device to satisfy the request for the one or more secure containers;
transmitting, by the one or more processors, the key value to the second computing device when the second computing device establishes communication with the one or more secure containers; and
transmitting, by the one or more processors, a notification upon receiving a message that the computing device instructed one or more fasteners of the one or more secure containers to unlock.

17. The method of claim 16, wherein the request comprises an identifier of the second computing device, and wherein the second computing device is identified based on the request.

18. The method of claim 16, wherein generating the key value comprises generating a hash value of the identifier of the computing device.

19. The method of claim 16, further comprising:
associating, by the one or more processors, the key value with the one or more secure containers upon identifying the second computing device; and
removing, by the one or more processors, the association between the key value and the one or more secure containers upon receiving the notification.

20. The method of claim 16, further comprising identifying, by the one or more processors, the second computing device based on a requested number of the one or more secure containers.
